(19) United States
(12) Patent Application Publication
(10) Pub. No.: US 2025/0113327 A1
(43) Pub. Date: Apr. 3, 2025

(54) INTERFERENCE MITIGATION IN SATELLITE COMMUNICATION

(71) Applicant: Apple Inc., Cupertino, CA (US)

(72) Inventors: Dhruv Khati, San Jose, CA (US); Sanjeevi Balasubramanian, San Jose, CA (US); Anjaneyulu Maganti, San Jose, CA (US); Krishna Myneni, San Jose, CA (US); Venkateswara Rao Manepalli, San Jose, CA (US)

(21) Appl. No.: 18/671,676

(22) Filed: May 22, 2024

Related U.S. Application Data
(60) Provisional application No. 63/541,218, filed on Sep. 28, 2023.

(51) Int. Cl. H04W 64/00; H04B 7/185; H04B 17/318; H04W 8/22

(52) U.S. Cl. CPC H04W 64/00; H04B 7/18513; H04B 17/328; H04W 8/22

(57) ABSTRACT

This disclosure is directed to systems and methods for interference mitigation in satellite communication. For satellite communication, an electronic device may perform a GNSS position fix prior to establishing satellite communication. In some cases, a GNSS downlink frequency band may be close to a satellite uplink frequency band, and as a result a first device communicatively connecting to a satellite downlink frequency band may interfere with one or more other devices in close proximity attempting to connect to the GNSS uplink frequency band, and consequently the first device may prevent the one or more other devices from performing the GNSS position fix. Because of this, one electronic device may block satellite communication for multiple other electronic devices. This may be particularly relevant in situations involving large crowds (e.g., festivals, sporting events), during calamity events, and/or in outdoor scenarios (e.g., group hikes).

### CROSS-REFERENCE TO RELATED APPLICATIONS

This application claims to the benefit of U.S. Provisional Application No. 63/541,218, filed Sep. 28, 2023, entitled “Interference Mitigation in Satellite Communication,” which is incorporated by reference herein in its entirety for all purposes.

### BACKGROUND

The present disclosure relates generally to wireless communication, and more specifically to mitigating interference in wireless communication.

For satellite communication, an electronic device may perform a global navigation satellite system (GNSS) position fix prior to establishing satellite communication. In some cases, a GNSS downlink frequency band may be close to a satellite uplink frequency band, and as a result a first device communicatively connecting to a satellite downlink frequency band may interfere with one or more other devices in close proximity attempting to connect to the GNSS uplink frequency band. Consequently, the first device may prevent the one or more other devices from performing the GNSS position fix. Because of this, one electronic device may block satellite communication for multiple other electronic devices.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device may include a plurality of antennas; receive circuitry coupled to the plurality of antennas and configured to receive a location signal via a satellite node; transmit circuitry coupled to the plurality of antennas; and processing circuitry coupled to the receive circuitry and the transmit circuitry, the processing circuitry configured to receive a first indication that the receive circuitry has failed to receive the location signal, receive a second indication that interference from an additional electronic device is causing the receive circuitry to fail to receive the location signal, and transmit, via the transmit circuitry, a request that the additional electronic device perform an action to mitigate the interference.

In another embodiment, a ground station may include a plurality of antennas; a receiver coupled to the plurality of antennas; a transmitter coupled to the plurality of antennas; and processing circuitry configured to receive, via the receiver, a signal from a first electronic device, the signal comprising an indication that the first electronic device has failed to connect to a global navigation satellite system (GNSS) location signal for a time greater than a threshold amount of time, an indication of interference from a second electronic device, an indication of an estimated distance between the first electronic device and the second electronic device, and an indication of a unique device identifier corresponding to the second electronic device, and perform an action to mitigate the interference between the second electronic device and the first electronic device based on the estimated distance and the unique device identifier.

In yet another embodiment, a ground station may include a plurality of antennas; a receiver coupled to the plurality of antennas; a transmitter coupled to the plurality of antennas; and processing circuitry configured to receive, via the receiver, a first indication of a first location of first user equipment and a second location of second user equipment, receive a second indication of an interference area indicating a proximity at which the second user equipment is anticipated to interfere with the first user equipment, receive a third indication that the first user equipment and the second user equipment are within the interference area, and perform an action to mitigate interference from the second user equipment on the first user equipment.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of a transmitter of the electronic device of FIG. 1, according to embodiments of the present disclosure;

FIG. 4 is a schematic diagram of a receiver of the electronic device of FIG. 1, according to embodiments of the present disclosure;

FIG. 5 is a schematic diagram of a communication system that includes a global navigational satellite system (GNSS) network, a non-terrestrial network (NTN), and two devices that seek to communicate using the NTN, according to embodiments of the present disclosure;

FIG. 6 is an illustration of interference mitigation between various electronic devices within close proximity, according to embodiments of the present disclosure;

FIG. 7 is a flowchart of a method for the user equipment of FIG. 1 to determine that GNSS position fix has failed and request that interfering user equipment perform one or more actions to mitigate downlink interference on the user equipment, according to embodiments of the present disclosure;

FIG. 8 illustrates a system for mitigating interference between user equipment in close proximity by sharing unique device identifiers between various user equipment and sharing the unique identifiers with the ground station of FIG. 5, according to embodiments of the present disclosure;

FIG. 9 is a flowchart of a method for mitigating interference between user equipment in close proximity by sharing unique device identifiers between various user equipment and sharing the unique identifiers with a ground station, according to embodiments of the present disclosure;

FIG. 10 is a diagram of a system in which the ground station may determine an area indicating a threshold distance within which a device attempting to obtain a GNSS position fix may experience interference from one or more other devices communicating with a satellite communication node, wherein the ground station may perform one or more actions to mitigate interference on the device from the one or more other devices within the threshold distance, according to embodiments of the present disclosure;

FIG. 11 is a flowchart of a method for determining an area indicating a threshold distance within which a device attempting to obtain a GNSS position fix may experience interference from one or more other devices communicating with a satellite communication node, and performing one or more actions to mitigate interference on the device from the one or more other devices within the threshold distance, according to embodiments of the present disclosure;

FIG. 12 is diagram illustrating how the user equipment may determine that connection with GNSS is failing, and prompt a user to perform actions to attempt to mitigate any potential interference from other user equipment in the area, according to embodiments of the present disclosure;

FIG. 13 is a flowchart of a method for determining that connection between the user equipment and GNSS is failing, and prompting a user to perform actions to attempt to mitigate potential interference from interfering user equipment, according to embodiments of the present disclosure;

FIG. 14 is a diagram illustrating integration of interference detection and satellite connection assistance, according to embodiments of the present disclosure; and

FIG. 15 is a flowchart of a method for determining interference on the user equipment and determining a pointing direction of the user equipment to reduce interference while increasing exposure towards the direction of the satellite, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising.” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to systems and methods for interference mitigation in satellite communication. For satellite communication, an electronic device may perform a GNSS position fix prior to establishing satellite communication. In some cases, a GNSS downlink frequency band may be close to a satellite uplink frequency band, and as a result a first device communicatively connecting to a satellite downlink frequency band may interfere with one or more other devices in close proximity attempting to connect to the GNSS uplink frequency band, and consequently the first device may prevent the one or more other devices from performing the GNSS position fix. Because of this, one electronic device may block satellite communication for multiple other electronic devices. This may be particularly relevant in situations involving large crowds (e.g., festivals, sporting events), during calamity events, and/or in outdoor scenarios (e.g., group hikes).

In some embodiments, the first device may be prevented from blocking the one or more other devices in close proximity based on a direct request from a second device of the one or more other devices to the first device. The second device may transmit an advertisement beacon to the first device, to which the first device may respond with a beacon acknowledgement. Based on one or more characteristics of the beacon acknowledgement (e.g., a received signal strength indicator (RSSI) measurement), the second device may estimate a distance between the second device and the first device. Based on the estimated distance, the second device may request that the first device refrain from transmitting or transmit at a reduced power until the second device is able to perform a GNSS position fix and establish satellite communication.

In some embodiments, the second device may determine that the GNSS connection has failed for an amount of time greater than a threshold amount of time, and transmit an advertisement beacon based on this determination. The second device may receive, from the first device, a beacon acknowledgement including an RSSI measurement and a unique identifier associated with the first device. The second device may determine an estimated distance from the second device based on the RSSI measurement, and transmit the estimated distance the unique identifier to the base station. A base station may receive the estimated distance the unique identifier, and determine whether the first device is a threshold distance from the second device and, if so, the base station may refrain from scheduling the first device for uplink, or may schedule the first device on a different frequency that is less likely to interfere with the downlink of the second device.

In some embodiments, a base station receives GNSS coordinates from the first device and the second device and determines a potential interference area within which the first device may interfere with the second device. The base station may, based on the GNSS coordinates of the first device and the second device, track the first device and the second device. The base station may receive an indication from the second device that the second device is attempting to acquire a GNSS signal or has failed to acquire a GNSS signal for more than a threshold amount of time. The base station may determine if the first device and the second device are within the potential interference area and, if so, refrain from scheduling the first device for uplink transmission or to schedule the first device on a different frequency less likely to interfere with the downlink of the first device.

In some embodiments, the second device determines a failure to establish a GNSS connection for an amount of time greater than a threshold amount of time. The second device may transmit a prompt to a user suggesting that the user perform a 360-degree azimuth turn. During the 360-degree azimuth turn, the second device may determine interference at each azimuth angle. The second device may prompt the user to face the direction of least interference.

In some embodiments, the second device determines a failure to latch onto a satellite network. The second device may prompt the user to perform a 360-degree azimuth turn. During the 360-degree azimuth turn, the second device may determine interference at each azimuth angle, and determine whether the second device receives a view of a satellite in the satellite network. Based on the determined interference at each azimuth angle, the second device may transmit a prompt to the user instructing the user to face a desired direction.

While satellite communication is discussed, it should be noted that other forms of non-terrestrial communication such as a high-altitude platform system (HAPS) network, an air-to-ground network, and so on may be applicable herein. Additionally, as used herein, a satellite may include any airborne or spaceborne object that has been intentionally placed into orbit, such as a conventional spaceborne orbital satellite having a geostationary or geosynchronous orbit (GEO) at approximately 36,000 kilometers, medium-Earth orbit (MEO) at approximately 7,000 kilometers to 20,000 kilometers, or low-Earth orbit (LEO) at approximately 300 meters to 1,500 kilometers. In additional or alternative embodiments, a satellite node may include any airborne device or vehicle or atmospheric satellite, such as balloon satellites, manned aircraft (e.g., an airplane, an airship, or any other aircraft) or unmanned aircraft systems (UASs), HAPS, and so on. Further, the satellite may include a network or constellation of any of the non-terrestrial vehicles, devices, and/or satellites above.

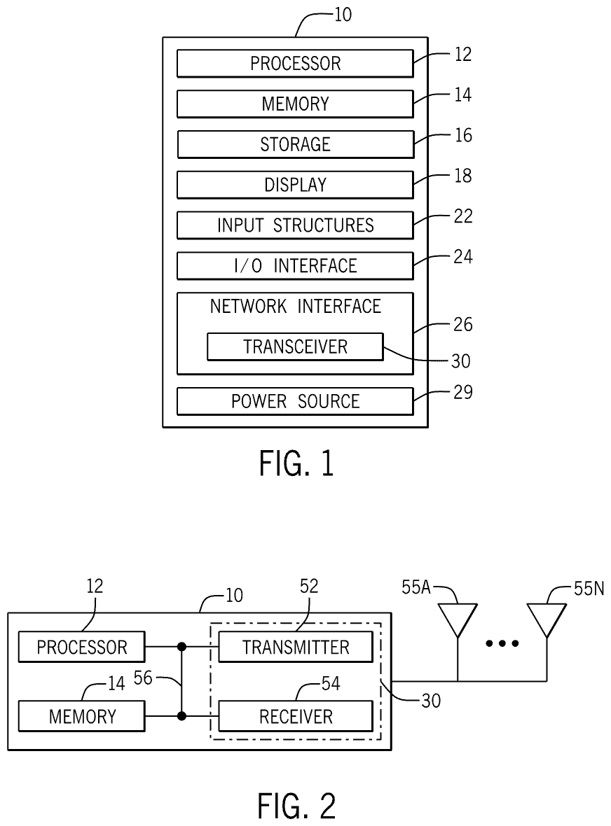

FIG. 1 is a block diagram of an electronic device (e.g., user equipment) 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer, a portable electronic or handheld electronic device such as a wireless electronic device or smartphone, a tablet, a wearable electronic device, and other similar devices. In additional or alternative embodiments, the user equipment 10 may include an access point, such as a ground station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein (e.g., determining interference on a first device caused by a second device).

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible. computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution® (LTE) cellular network. Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. For example, the transceiver may support transmitting an advertisement beacon, receiving a beacon acknowledgement, and submitting (to an interfering device) a request that the interfering device refrain from transmitting or transmit at a reduced power until a device (e.g., the user equipment 10) is able to perform GNSS position fix. The power source 29 of the user equipment 10 may include any suitable source of power, such as a rechargeable lithium polymer (Li-poly) battery and/or an alternating current (AC) power converter.

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The user equipment 10 may include the transmitter 52 and/or the receiver 54 that respectively enable transmission and reception of signals between the user equipment 10 and an external device via, for example, a network (e.g., including ground stations or access points) or a direct connection. As illustrated, the transmitter 52 and the receiver 54 may be combined into the transceiver 30. The user equipment 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the user equipment 10 may be coupled together by a bus system 56. The bus system 56 may include a data bus, for example, as well as a power bus, a control signal bus, and a status signal bus, in addition to the data bus. The components of the user equipment 10 may be coupled together or accept or provide inputs to each other using some other mechanism.

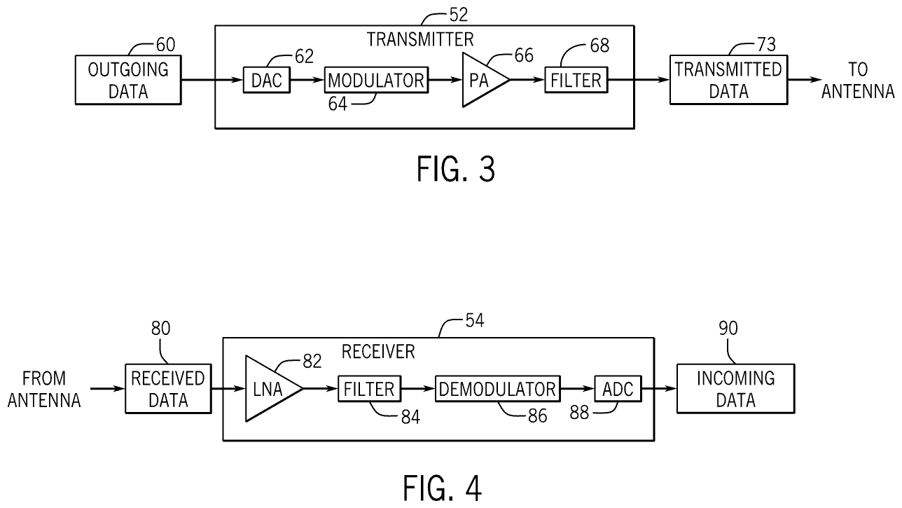

FIG. 3 is a schematic diagram of the transmitter 52 (e.g., transmit circuitry), according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 64 may combine the converted analog signal with a carrier signal to generate a radio wave. A power amplifier (PA) 66 receives the modulated signal from the modulator 64. The power amplifier 66 may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted signal 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter.

The power amplifier 66 and/or the filter 68 may be referred to as part of a radio frequency front end (RFFE), and more specifically, a transmit front end (TXFE) of the user equipment 10. Additionally, the transmitter 52 may include any suitable additional components not shown, or may not include certain of the illustrated components, such that the transmitter 52 may transmit the outgoing data 60 via the one or more antennas 55. For example, the transmitter 52 may include a mixer and/or a digital up converter. As another example, the transmitter 52 may not include the filter 68 if the power amplifier 66 outputs the amplified signal in or approximately in a desired frequency range (such that filtering of the amplified signal may be unnecessary).

FIG. 4 is a schematic diagram of the receiver 54 (e.g., receive circuitry), according to embodiments of the present disclosure. As illustrated, the receiver 54 may receive received signal 80 from the one or more antennas 55 in the form of an analog signal. A low noise amplifier (LNA) 82 may amplify the received analog signal to a suitable level for the receiver 54 to process. A filter 84 (e.g., filter circuitry and/or software) may remove undesired noise from the received signal, such as cross-channel interference. The filter 84 may also remove additional signals received by the one or more antennas 55 that are at frequencies other than the desired signal. The filter 84 may include any suitable filter or filters to remove the undesired noise or signals from the received signal, such as a bandpass filter, a bandstop filter, a low pass filter, a high pass filter, and/or a decimation filter. The low noise amplifier 82 and/or the filter 84 may be referred to as part of the RFFE, and more specifically, a receiver front end (RXFE) of the user equipment 10.

A demodulator 86 may remove a radio frequency carrier signal and/or extract a demodulated signal (e.g., an envelope signal) from the filtered signal for processing. An analog-to-digital converter (ADC) 88 may receive the demodulated analog signal and convert the signal to a digital signal of incoming data 90 to be further processed by the user equipment 10. Additionally, the receiver 54 may include any suitable additional components not shown, or may not include certain of the illustrated components, such that the receiver 54 may receive the received signal 80 via the one or more antennas 55. For example, the receiver 54 may include a mixer and/or a digital down converter. While FIGS. 1-4 are described with respect to the user equipment 10, it should be noted that the same devices and components may be present in a ground station as well. For example, a ground station may use a processor 12, the transmitter 52, and the receiver 54 to communicate with satellites and user equipment.

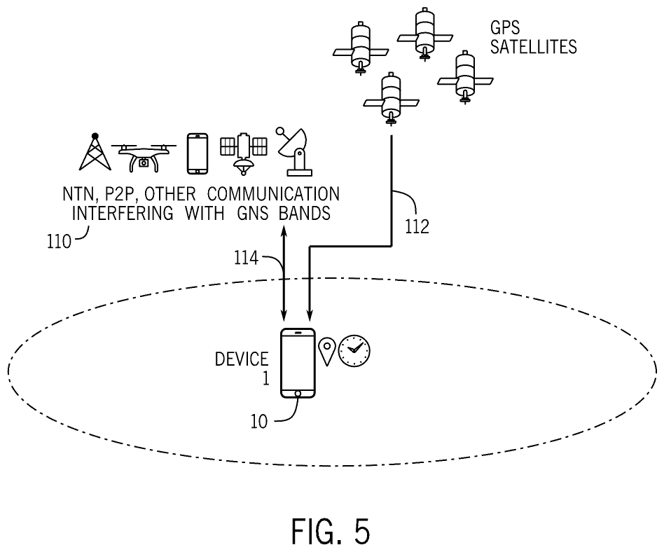

FIG. 5 is a schematic diagram of a communication system that includes a GNSS, an NTN, GPS satellites, a ground station, and user equipment 10 that seeks to communicate using the NTN 110 (illustrated as part of the “NTN, P2P, other communication interfering with GNSS bands”). In particular, the user equipment 10 may seek to start an NTN, P2P, or other communication session with another device or infrastructure. It may start with receiving and decoding GNSS signals 112 (e.g., a GNSS position fix signal) to get a time reference and position and velocity estimates. In this way, the user equipment 10 determines its position and precise time from the GNSS signals 112. Using the precise time and position from the GNSS, the user equipment 10 starts NTN/P2P/other communication with transmission energy leaking from the NTN/P2P/other communication signal 114 in GNSS L1 and/or L5 bands. This GNSS band interference (as depicted by the large oval on the ground centered about the user equipment 10) envelops or may cover an area that includes nearby user equipment. This area may be of any range where the interference occurs (e.g., 5 meters (m) or less, 10 m or less, 15 m or less, 20 m or less, 20 m or more, and so on). As a result, nearby user equipment may not receive GNSS/GPS signals (e.g., a GNSS position fix) and is denied GNSS/GPS service for precise time determination, which prohibits or prevents the nearby user equipment from participating in NTN, P2P, other communication like the user equipment 10.

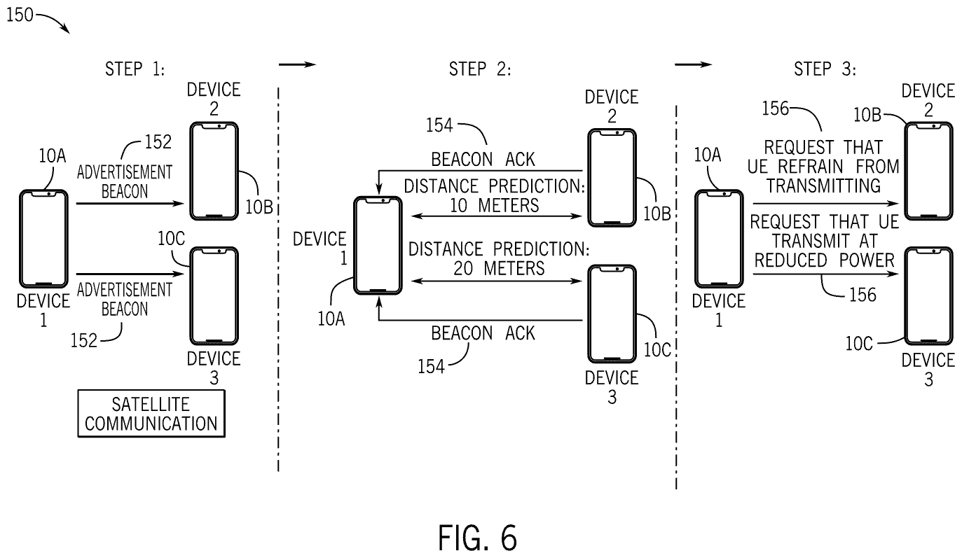

FIG. 6 is an illustration 150 of interference mitigation between various electronic devices within close proximity, according to embodiments of the present disclosure. FIG. 6 includes user equipment 10A, user equipment 10B and user equipment 10C (collectively, the user equipment 10). As discussed above an electronic device (e.g., the user equipment 10) may perform a GNSS position fix prior to establishing satellite communication. In some cases, a GNSS downlink frequency band (e.g., the GNSS signals 112) may be close to a satellite uplink frequency band (e.g., the NTN/P2P/other communication signal 114), and as a result a first device or group of devices (e.g., the user equipment 10B or 10C) communicatively connecting to a satellite uplink frequency band may interfere with one or more other devices (e.g., the user equipment 10A) in close proximity attempting to connect to the GNSS downlink frequency band. Consequently, the user equipment 10B and/or 10C may prevent the user equipment 10A from obtaining the GNSS position fix. Because of this, the user equipment 10B and 10C may block satellite communication for multiple other electronic devices, including the user equipment 10A. Systems and methods will be discussed with respect to the following figures to prevent or mitigate such interference, enabling the user equipment 10A, 10B, and 10C to obtain GNSS position fix and access satellite communication.

In step 1, the user equipment 10A may transmit respective advertisement beacons 152 to the user equipment 10B and the user equipment 10C. The advertisement beacon 152 may be transmitted over Bluetooth, Bluetooth Low Energy (BLE) or any other appropriate wireless communication technology. The advertisement beacons 152 may include location data (e.g., latitude and longitude data), a request for acknowledgement, a request for a received signal strength indicator (RSSI) measurement, or any combination thereof.

In step 2, the user equipment 10B and 10C may respond to the advertisement beacons 152 with respective beacon acknowledgements 154. The beacon acknowledgements 154 may include an RSSI measurement based on the strength of the advertisement beacons 152, a unique identifier associated with the corresponding user equipment 10, and so on. The user equipment 10A may, based on the beacon acknowledgements 154, determine estimated distances between the user equipment 10A and the respective user equipment 10B and 10C. Based on the estimated distances, the user equipment 10A may request that the user equipment 10B and 10C either refrain from transmitting (e.g., deactivate transmission) for a period of time, may request that the user equipment 10B and 10C transmit at a lower power for a period of time, or may take no action. In step 3, the user equipment 10A may transmit a request 156 that the user equipment 10B refrain from transmitting entirely (e.g., deactivate transmission for a period of time) and may transmit a request 158 that the user equipment 10C transmit at a reduced power (e.g., for a period of time) to mitigate or eliminate interference between the satellite (e.g., GPS, GNSS) uplink of the user equipment 10B and 10C and the GNSS downlink of the user equipment 10A. In doing so, the user equipment 10A may be enabled to perform a GNSS position fix and proceed with establishing satellite communication.

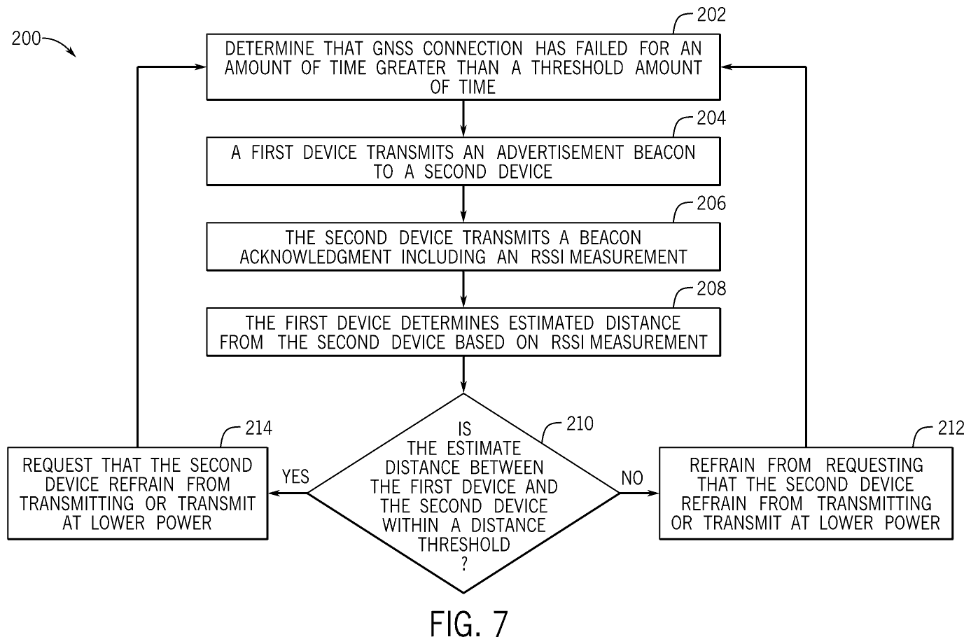

FIG. 7 is a flowchart of a method 200 for the user equipment 10A to determine that GNSS position fix has failed and request that the user equipment 10B and 10C perform one or more actions to mitigate downlink interference on the user equipment 10A, according to embodiments of the present disclosure. Any suitable device (e.g., a controller) that may control components of the user equipment 10, such as the processor 12, may perform the method 200. In some embodiments, the method 200 may be implemented by executing instructions stored in a tangible, non-transitory, computer-readable medium, such as the memory 14 or storage 16, using the processor 12. For example, the method 200 may be performed at least in part by one or more software components, such as an operating system of the user equipment 10, one or more software applications of the user equipment 10, and the like. While the method 200 is described using steps in a specific sequence, it should be understood that the present disclosure contemplates that the described steps may be performed in different sequences than the sequence illustrated, and certain described steps may be skipped or not performed altogether.

In process block 202, the processor 12 (e.g., the processor 12 of the user equipment 10A) determines that a GNSS connection has failed for an amount of time greater than a threshold amount of time. Additionally or alternatively, the processor 12 of the user equipment 10A may receive an indication that the receiver 54 has failed to connect to GNSS for an amount of time greater than the threshold amount of time. The threshold amount of time may include 100 millisecond or more, 1 second or more, 10 seconds or more, and so on. As previously stated, this failed GNSS connection may include a failure to obtain a GNSS position fix associated with the user equipment 10A. The user equipment 10A may determine if the failed connection is due to a satellite downlink connection interference from nearby user equipment (e.g., 10B and 10C). In process block 204, the user equipment 10A may transmit the advertisement beacons 152 to the one or more other devices within range of the advertisement beacon (e.g., the user equipment 10B and/or 10C). As mentioned above, the advertisement beacon 152 may be transmitted over Bluetooth, Bluetooth Low Energy (BLE) or any other appropriate wireless communication technology. The advertisement beacons 152 may include location data (e.g., latitude and longitude data), a request for acknowledgement, a request for a received signal strength indicator (RSSI) measurement, or any combination thereof.

In process block 206, the user equipment 10B and 10C transmit the beacon acknowledgements to the user equipment 10A. As previously noted, the beacon acknowledgements 154 may include an RSSI measurement based on the strength of the advertisement beacons 152, a unique identifier associated with the corresponding user equipment 10, latitude and longitude data, and so on. In process block 208, the user equipment 10A determines respective estimated distances to the user equipment 10B and 10C. The distance estimations may be based on the RSSI from the user equipment 10B and 10C, the longitude and latitude data, and so on. In query block 210, the user equipment 10A determines if the estimated distances corresponding to the distance between the user equipment 10A and the user equipment 10B and the user equipment 10A and the user equipment 10C are within a distance threshold. If the user equipment 10A determines that the user equipment 10B and 10C are indeed within the threshold distances (e.g., less than or equal to the threshold distance), the user equipment 10A may, in process block 214, request that the user equipment 10B and 10C either refrain from transmitting the GPS uplink signals or transmit the GPS uplink signals at a lower power to reduce interference with the GNSS downlink signals of the user equipment 10A. However, if, in the query block 210, the user equipment 10A determines that the user equipment 10B and 10C are not within the threshold distance (e.g., the distances are greater than the threshold distance), in process block 212 the user equipment 10A may refrain from requesting that the user equipment 10B and 10C refrain from transmitting on the GPS uplink or transmit the GPS uplink signals at a lower power.

It should be noted that the threshold distances discussed above may include multiple threshold distances. For instance, at a first threshold distance, (e.g., 10 meters or nearer) the user equipment 10A may request that the user equipment 10B and 10C stop transmitting completely, while at a second threshold distance (10 meters-20 meters), the user equipment 10A may merely request that the user equipment 10B and 10C transmit at a lower power. It should be noted that these distance thresholds are merely illustrative, and the distance thresholds may include any appropriate threshold distances. Moreover, this technique is not limited to two nearby devices (e.g., the user equipment 10B and 10C), and may apply to any number of nearby devices. In this manner, the method 200 enables the user equipment 10 to determine that GNSS position fix has failed and request that the user equipment 10B and 10C perform one or more actions to mitigate downlink interference on the user equipment 10A.

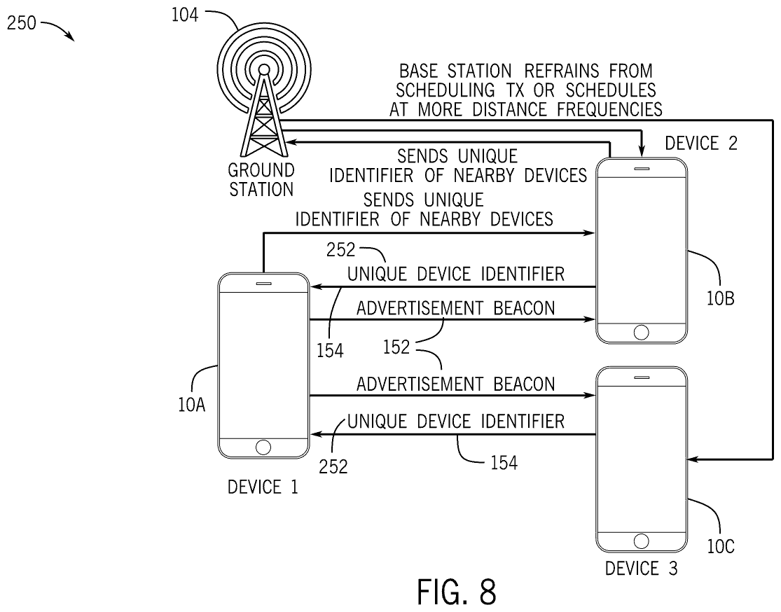

FIG. 8 illustrates a system 250 for mitigating interference between user equipment 10 in close proximity by sharing unique device identifiers between various user equipment 10 and sharing the unique identifiers with a ground station 104, according to embodiments of the present disclosure. The system 250 includes the ground station 104 and the user equipment 10A. 10B, and 10C. The user equipment 10A. 10B. and 10C may send advertisement beacons and, in response, may send beacon acknowledgements including unique device identifiers 252.

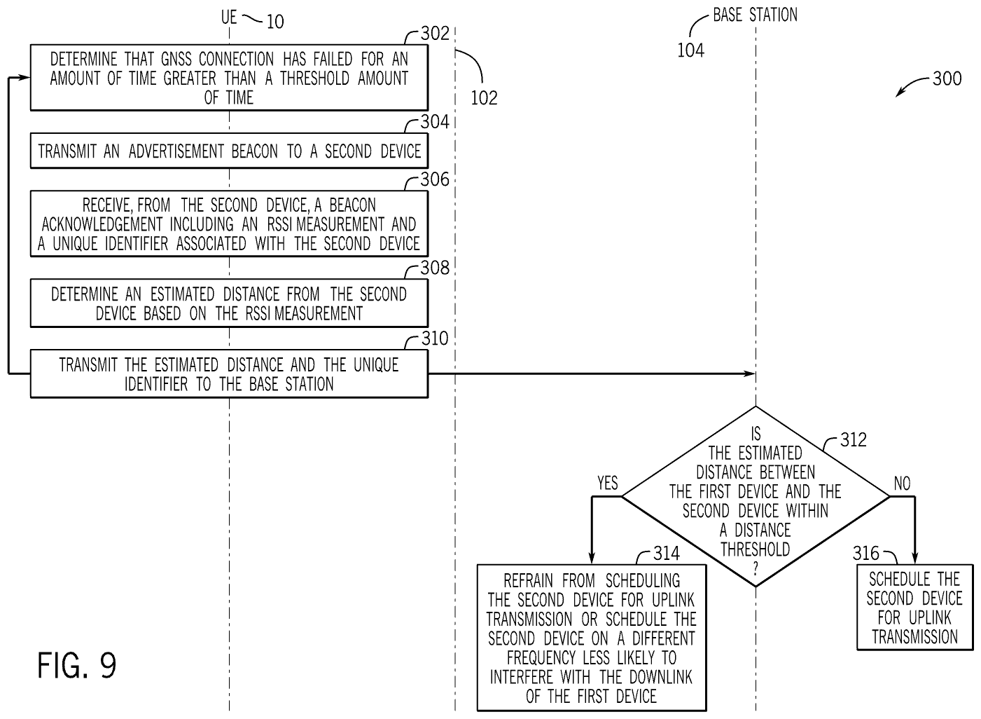

FIG. 9 is a flowchart of a method 300 for mitigating interference between user equipment 10 in close proximity by sharing unique device identifiers between various user equipment 10 and sharing the unique identifiers with a ground station 104, according to embodiments of the present disclosure. Any suitable device (e.g., a controller) that may control components of the user equipment 10, such as the processor 12, may perform the method 300. In some embodiments, the method 300 may be implemented by executing instructions stored in a tangible, non-transitory, computer-readable medium, such as the memory 14 or storage 16, using the processor 12. For example, the method 300 may be performed at least in part by one or more software components, such as an operating system of the user equipment 10, one or more software applications of the user equipment 10, and the like. While the method 300 is described using steps in a specific sequence, it should be understood that the present disclosure contemplates that the described steps may be performed in different sequences than the sequence illustrated, and certain described steps may be skipped or not performed altogether.

In process block 302, the user equipment 10A may determine that an attempted GNSS connection has failed for an amount of time greater than a threshold amount of time, as described with respect to the process block 202 of FIG. 7. Additionally or alternatively, the processor 12 of the user equipment 10A may receive an indication that the receiver 54 has failed to connect to GNSS for an amount of time greater than the threshold amount of time. In process block 304, the user equipment 10A may transmit the advertisement beacons 152 to the user equipment 10B and 10C, as described with respect to the process block 204 of FIG. 7. In process block 306, the user equipment 10B and 10C may respond to the advertisement beacons 152 with beacon acknowledgements 154 including an RSSI measurement based on the strength of the advertisement beacons 152, latitude and longitude data, and unique device identifiers 252 corresponding to each respective electronic device within range of the advertisement beacons 152 (e.g., the user equipment 10B and 10C). In process block 308, the user equipment 10A may determine an estimated distance from the user equipment 10B and 10C based on the RSSI measurement. In process block 310, the user equipment 10A may transmit the estimated distance and the unique device identifiers 252 corresponding to the respective devices to the ground station 104 via the network. The ground station 104 may receive the unique device identifiers 252 and the estimated distances from the user equipment 10A. In some embodiments, the user equipment 10A may transmit the unique identifiers and the estimated distances to an intermediary device (e.g., the user equipment 10B), which may route the information to the ground station 104.

The ground station 104 may, in query block 312, determine if the estimated distance between the user equipment 10A and the respective user equipment 10B and 10C falls within a threshold distance. If the estimated distance falls within the threshold distance (e.g., is less than or equal to the threshold distance), in process block 314 the ground station 104 may refrain from scheduling the user equipment 10B and 10C for uplink. Alternatively, the ground station 104 may schedule the user equipment 10B and 10C on different frequencies, such as frequencies in a different channel or in a different band, or otherwise a desirable distance away from the downlink channel of the user equipment 10A. However, if the estimated distance falls outside of the threshold distance (e.g., is greater than the threshold distance), in process block 316 the ground station 104 may schedule the user equipment 10B and 10C as normally.

It should be noted that, while the above is discussed with respect to ground stations 104 (e.g., terrestrial ground stations), the same systems and methods may be applied to a satellite node or other non-terrestrial ground station or node. In this manner the method 300 may mitigate interference between user equipment 10 in close proximity by determining interference at a first device and informing a ground station 104 of the interfering devices by sharing unique device identifiers with the ground station 104.

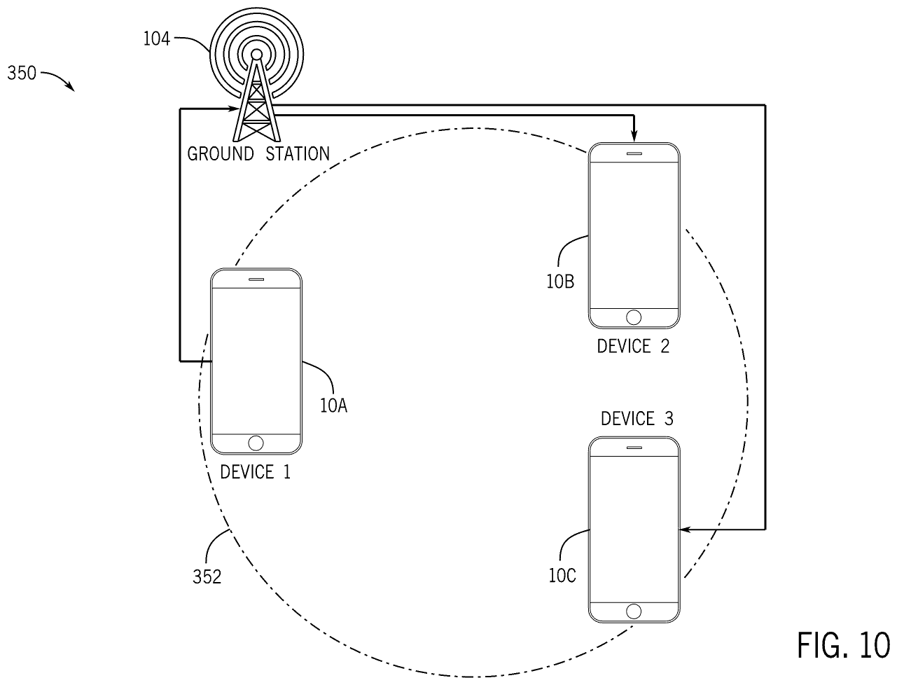

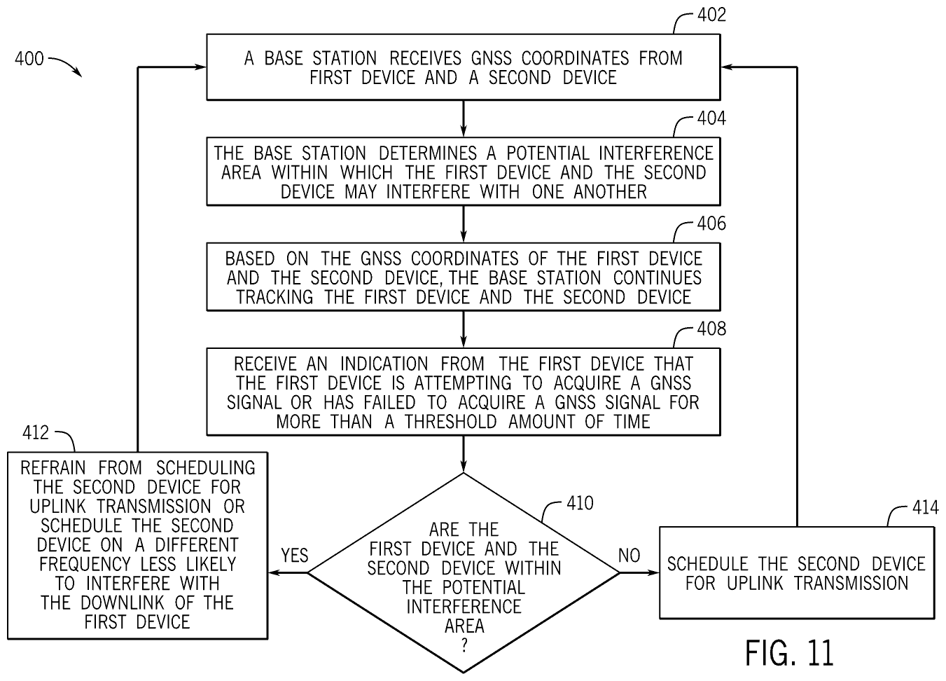

FIG. 10 is a diagram of a system 350 in which the ground station 104 may determine an area indicating a threshold distance within which a device attempting to obtain a GNSS position fix may experience interference from one or more other devices communicating with a satellite communication node, wherein the ground station 104 may perform one or more actions to mitigate interference on the device from the one or more other devices within the threshold distance, according to embodiments of the present disclosure. The system 350 may include the ground station 104 and the user equipment 10A, 10B, and 10C. As will be discussed with respect to FIG. 11 below, the ground station determines the potential interference area 352 indicating a threshold distance in which a device (e.g., the user equipment 10A) attempting to obtain a GNSS position fix may experience interference from one or more other devices (e.g., the user equipment 10B and 10C) communicating with a satellite communication node.

FIG. 11 is a flowchart of a method 400 for determining an area indicating a threshold distance within which a device attempting to obtain a GNSS position fix may experience interference from one or more other devices communicating with a satellite communication node, and performing one or more actions to mitigate interference on the device from the one or more other devices within the threshold distance, according to embodiments of the present disclosure. Any suitable device (e.g., a controller) that may control components of the ground station 104, such as the processor 12, may perform the method 400. In some embodiments, the method 400 may be implemented by executing instructions stored in a tangible, non-transitory, computer-readable medium, such as the memory 14 or storage 16, using the processor 12. For example, the method 400 may be performed at least in part by one or more software components, such as an operating system of the ground station 104, one or more software applications of ground station 104. and the like. While the method 400 is described using steps in a specific sequence, it should be understood that the present disclosure contemplates that the described steps may be performed in different sequences than the sequence illustrated, and certain described steps may be skipped or not performed altogether.

In process block 402, the ground station 104 may receive location data (e.g., GNSS coordinates) from multiple devices (e.g., each of the user equipment 10A. 10B, and 10C) within range of and communicatively coupled to the ground station 104. The location data may include latitude and longitude information, an indication of distance between the ground station 104 and the user equipment 10 (e.g., based on RSSI or another signal strength measurement), and so on. In process block 404, the ground station 104 determines a potential interference area 352 within which the user equipment 10 may interfere with one another. In additional or alternative embodiments, the ground station 104 may receive an indication of the potential interference area 352 from the user equipment 10. In process block 406, the ground station 104 may track the locations of the user equipment 10 to determine if the user equipment 10 enters the potential interference area 352 or predict if the user equipment 10 is likely to enter the potential interference area 352 based on behavioral patterns of the user equipment 10 (e.g., behavioral patterns of the users of the user equipment 10). This prediction may be performed by a variety of means, including a machine learning algorithm. In process block 408 the ground station 104 receives an indication from the user equipment 10A that the user equipment 10A is attempting to acquire a GNSS signal (e.g., GNSS position fix) or has failed to acquire the GNSS signal for an amount of time greater than a threshold amount of time.

In query block 410, the ground station 104 will determine whether the user equipment 10A and the user equipment 10B and 10C are within the potential interference area 352. The ground station 104 may either make this determination on its own or receive indications from the user equipment 10 that the user equipment 10 are within the potential interference area 352. This information may assist the ground station 104 in determining whether the user equipment 10B and 10C are interfering with the GNSS downlink capabilities of the user equipment 10A. If the ground station 104 determines (or receives an indication that) the user equipment 10A. 10B, and 10C are within the potential interference area 352, in process block 412 the ground station 104 may refrain from scheduling the user equipment 10B and 10C for uplink. Alternatively, the ground station 104 may schedule the user equipment 10B and 10C on different frequencies, such as frequencies in a different channel or in a different band, or otherwise a desirable distance away from the downlink channel of the user equipment 10A. However, if the estimated distance falls outside of the threshold distance (e.g., is greater than the threshold distance), in process block 414 the ground station 104 may schedule the user equipment 10B and 10C as normally. In this manner, the method 400 provides for determining the potential interference area 352 that may indicate a threshold distance within which a device attempting to obtain a GNSS position fix may experience interference from one or more other devices communicating with a satellite communication node, and performing one or more actions to mitigate interference on the device from the one or more other devices within the threshold distance.

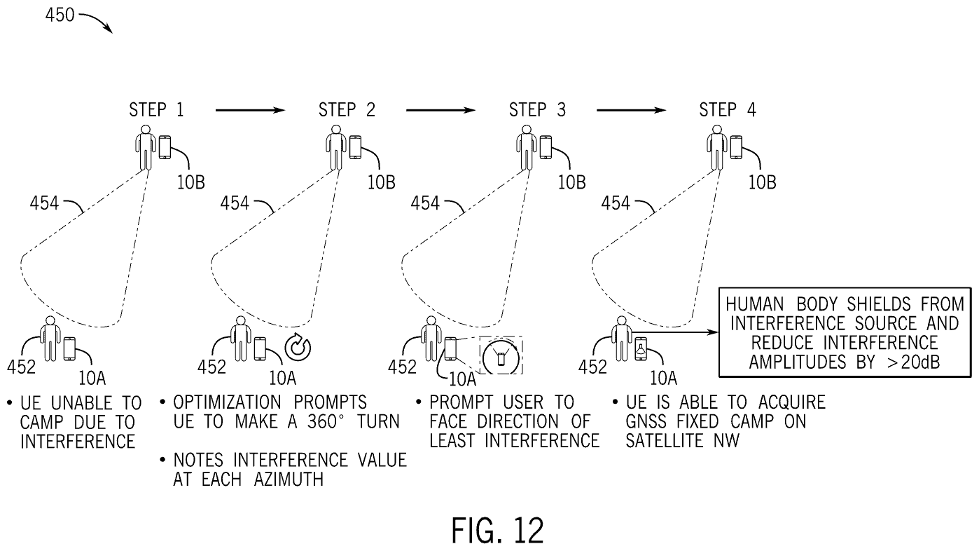

FIG. 12 is a diagram 450 illustrating how the user equipment 10 may determine that connection with GNSS is failing, and prompt a user to perform actions to attempt to mitigate any potential interference from other user equipment 10 in the area, according to embodiments of the present disclosure. The diagram 450 includes a user 452 having user equipment 10A. The user equipment 10A may attempt to communicate with GNSS to obtain a GNSS position fix. However, interference 454 from other user equipment 10B may prevent the user equipment 10A from obtaining the GNSS position fix and thus may prevent the user equipment 10A from establishing satellite communication.

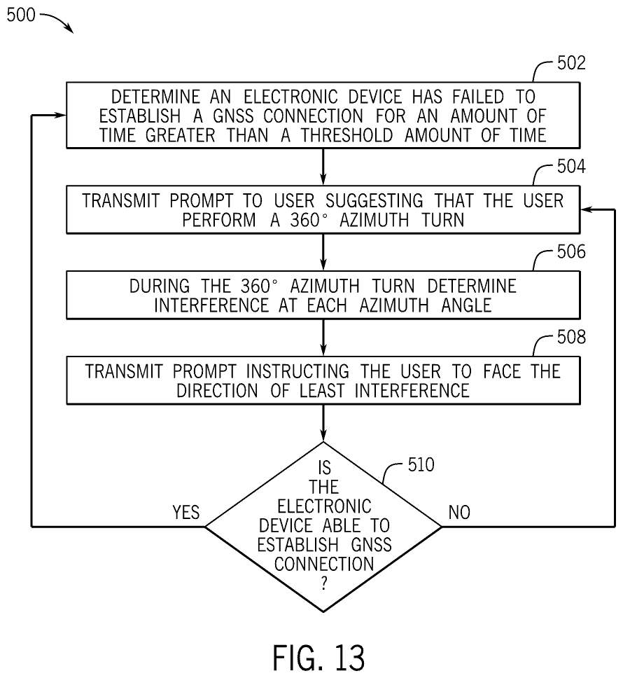

FIG. 13 is a flowchart of a method 500 for determining that connection between the user equipment 10A and GNSS is failing, and prompting the user 452 to perform actions to attempt to mitigate potential interference from the user equipment 10B, according to embodiments of the present disclosure. Any suitable device (e.g., a controller) that may control components of the user equipment 10, such as the processor 12, may perform the method 500. In some embodiments, the method 500 may be implemented by executing instructions stored in a tangible, non-transitory, computer-readable medium, such as the memory 14 or storage 16, using the processor 12. For example, the method 500 may be performed at least in part by one or more software components, such as an operating system of the user equipment 10, one or more software applications of the user equipment 10, and the like. While the method 500 is described using steps in a specific sequence, it should be understood that the present disclosure contemplates that the described steps may be performed in different sequences than the sequence illustrated, and certain described steps may be skipped or not performed altogether.

In process block 502, the user equipment 10A (e.g., the processor 12 of the user equipment 10) may determine that the user equipment 10A has failed to receive the GNSS position fix for a period of time greater than a threshold period of time. In process block 504, the processor 12 of the user equipment 10A may transmit a prompt (e.g., via push notification) to the user 452 suggesting that the user 452 perform a 360-degree azimuth turn. The processor 12 may provide additional instruction during the 360-degree azimuth turn. For example, the processor 12 may send an instruction to the user to turn faster or slower during the azimuth turn. As another example, the processor 12 may send an instruction to the user to move away from any nearby buildings or trees or lift the user equipment 10A higher. In process block 506, the processor 12 may determine an amount of interference 454 at each azimuth angle during the 360-degree azimuth turn. Based on the interferences at each azimuth angle of the 360-degree azimuth turn, the processor 12 may determine the direction corresponding to the least amount of interference 454 from the user equipment 10B. In process block 508 the processor 12 may transmit a prompt (e.g., via a push notification) for the user 452 to face the direction of least interference.

Briefly returning to FIG. 12, it may be observed (e.g., from Step 3) that an azimuth angle of least interference corresponds with a body position of the user 452 wherein the body of the user 452 is positioned between the interference 454 and the user equipment 10A. It should be noted that turning the body of the user 452 may align the user equipment 10A with the satellite, increasing signal strength. In query block 510 of the method 500, the processor 12 may determine if the user equipment 10A is able to establish GNSS connection and obtain the GNSS position fix after the user 452 has adjusted their body position. If the user equipment 10A is still unable to obtain the GNSS position fix, the method 500 repeats from the process block 504. If the user equipment 10A is able to obtain the GNSS position fix, the processor 12 may continue to monitor and determine if the electronic device has again failed to obtain GNSS position fix at a later time. In this manner, the method 500 may enable the user equipment 10A to determine that the connection between the user equipment 10A and GNSS is failing, and prompting the user 452 to perform actions to attempt to mitigate potential interference from the user equipment 10B and facilitate GNSS position fix.

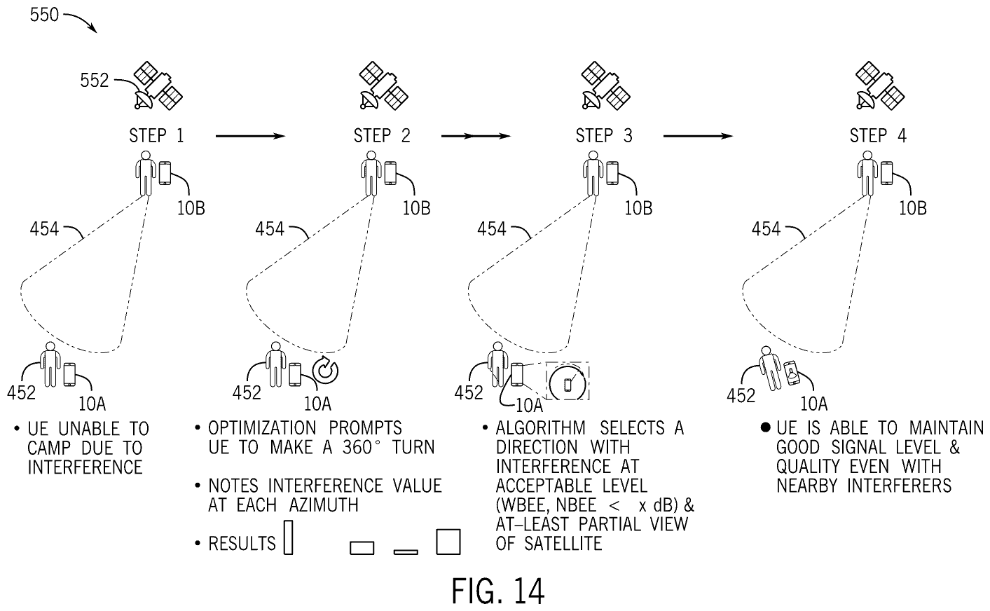

FIG. 14 is a diagram 550 illustrating integration of interference detection and satellite connection assistance, according to embodiments of the present disclosure. The diagram 550 includes the user 452, user equipment 10A, interference 454, interfering user equipment 10B, and a satellite 552. The user equipment 10A may include connection assistant guidance, which may track direction of the satellite 552 but may not be able to detect or determine near-cell interferers (e.g., the user equipment 10B). In some cases where the maximum interference is coming from the direction of the satellite 552, the user equipment 10A may experience difficulty camping on the service. To increase connectivity with the satellite, the user equipment 10A may find a pointing direction that corresponding to an acceptable level of interference while still facing partially or fully towards the satellite 552.

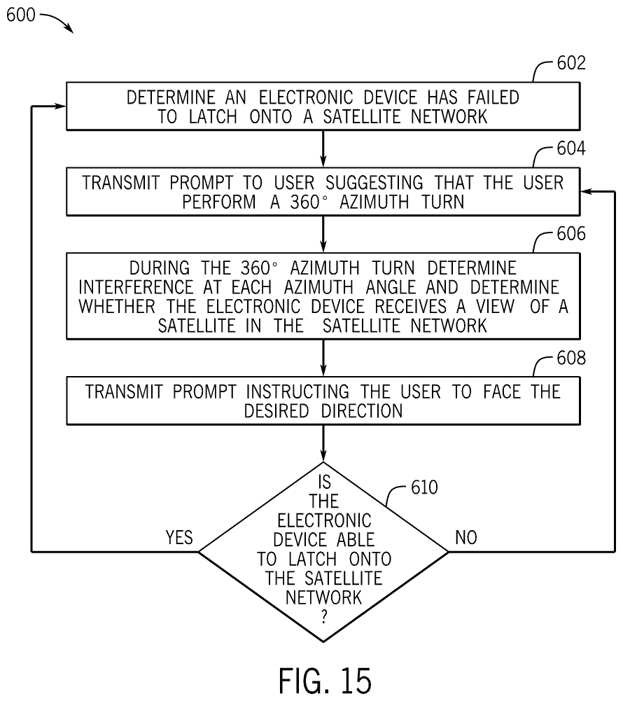

FIG. 15 is a flowchart of a method 600 for determining interference on the user equipment 10A and determining a pointing direction of the user equipment 10A to reduce interference while increasing exposure towards the direction of the satellite 552, according to embodiments of the present disclosure. Any suitable device (e.g., a controller) that may control components of the user equipment 10, such as the processor 12, may perform the method 600. In some embodiments, the method 600 may be implemented by executing instructions stored in a tangible, non-transitory, computer-readable medium, such as the memory 14 or storage 16, using the processor 12. For example, the method 600 may be performed at least in part by one or more software components, such as an operating system of the user equipment 10, one or more software applications of the user equipment 10, and the like. While the method 600 is described using steps in a specific sequence, it should be understood that the present disclosure contemplates that the described steps may be performed in different sequences than the sequence illustrated, and certain described steps may be skipped or not performed altogether.

In process block 602, the processor 12 may determine that the user equipment 10A has failed to latch onto a satellite 552 of the satellite network. In process block 604 the processor 12 may transmit a prompt (e.g., via a push notification) to the user 452 suggesting that the user perform a 360-degree azimuth turn, as described with respect to the process block 504 of FIG. 13. In process block 606, during the 360-degree azimuth turn, the processor 12 may determine the amount of interference 454 at each azimuth angle and determines whether the user equipment 10A receives a view of the satellite 552. An algorithm may perform an analysis to balance the degree of interference with the view of the satellite 552 at each azimuth angle such that the direction chosen corresponds to the lowest possible interference and the greatest possible view of the satellite 552. In some embodiments, the algorithm may select a direction with interference below a threshold level that has at least a partial view of the satellite 552. In process block 608 the processor 12 may transmit a prompt (e.g., via push notification) instructing the user to face the desired direction. In query block 610, the processor 12 determines if the user equipment 10A was able to latch onto the satellite network after facing the desired direction. If the user equipment 10A remains unable to latch onto the satellite network, the method 600 may repeat from the process block 604. If, at the query block 610, the processor 12 determines that the user equipment 10A is able to latch onto the satellite network, the processor 12 may continue to track the connection between the user equipment 10A and the satellite network to determine if the connection is broken or lost at some point in the future. In this manner, the method 600 enables determining interference on the user equipment 10A and determining a pointing direction of the user equipment 10A to reduce interference while increasing exposure towards the direction of the satellite 552.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform] ing [a function] . . . ” or “step for [perform] ing [a function] . . . ” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device, comprising:
a plurality of antennas;
receive circuitry coupled to the plurality of antennas and configured to receive a location signal via a satellite node;
transmit circuitry coupled to the plurality of antennas; and
processing circuitry coupled to the receive circuitry and the transmit circuitry, the processing circuitry configured to
receive a first indication that the receive circuitry has failed to receive the location signal,
receive a second indication that interference from an additional electronic device is causing the receive circuitry to fail to receive the location signal, and
transmit, via the transmit circuitry, a request that the additional electronic device perform an action to mitigate the interference.

2. The electronic device of claim 1, wherein the processing circuitry is configured to determine that the interference from the additional electronic device is causing the receive circuitry to fail to receive the location signal by
transmitting, via the transmit circuitry, a beacon signal, and
receiving, via the receive circuitry, a beacon acknowledgement comprising a received signal strength indicator (RSSI) from the additional electronic device.

3. The electronic device of claim 1, wherein the processing circuitry is configured to determine that the interference from the additional electronic device is causing the receive circuitry to fail to receive the location signal by determining an estimated distance between the electronic device and the additional electronic device based on a third indication of signal strength received from the additional electronic device.

4. The electronic device of claim 1, wherein the processing circuitry is configured to determine that the interference from the additional electronic device is causing the receive circuitry to fail to receive the location signal by determining an estimated distance between the electronic device and the additional electronic device falls within a threshold.

5. The electronic device of claim 1, wherein the processing circuitry is configured to request that the additional electronic device deactivate transmission capability for a period of time based on determining that the interference from the additional electronic device is causing the receive circuitry to fail to receive the location signal.

6. The electronic device of claim 1, wherein the processing circuitry is configured to request that the additional electronic device reduce transmission power for a period of time based on determining that the interference from the additional electronic device is causing the receive circuitry to fail to receive the location signal.

7. The electronic device of claim 1, wherein the location signal comprises a global navigation satellite system signal.

8. A ground station, comprising:
a plurality of antennas;
a receiver coupled to the plurality of antennas;
a transmitter coupled to the plurality of antennas; and
processing circuitry configured to
receive, via the receiver, a signal from a first electronic device, the signal comprising an indication that the first electronic device has failed to connect to a global navigation satellite system (GNSS) location signal for a time greater than a threshold amount of time, an indication of interference from a second electronic device, an indication of an estimated distance between the first electronic device and the second electronic device, and of a unique device identifier corresponding to the second electronic device, and
perform an action to mitigate the interference between the second electronic device and the first electronic device based on the estimated distance and the unique device identifier.

9. The ground station of claim 8, wherein the processing circuitry is configured to determine whether the second electronic device is within a threshold distance of the first electronic device based on receiving the estimated distance.

10. The ground station of claim 9, wherein the processing circuitry is configured to refrain from scheduling the second electronic device based on determining that the second electronic device is within the threshold distance of the first electronic device to mitigate the interference from the second electronic device.

11. The ground station of claim 9, wherein the processing circuitry is configured to schedule the second electronic device on a determined frequency based on determining that the second electronic device is within the threshold distance of the first electronic device to mitigate the interference from the second electronic device.

12. The ground station of claim 11, wherein the determined frequency is in a different frequency band than the GNSS location signal.

13. The ground station of claim 11, wherein the determined frequency is on a different frequency channel than the GNSS location signal.

14. The ground station of claim 11, wherein the indication of the estimated distance between the first electronic device and the second electronic device is based on the first electronic device transmitting a beacon signal and the second electronic device transmitting a received signal strength indicator (RSSI) measurement based on the beacon signal.

15. The ground station of claim 14, wherein the indication of the estimated distance between the first electronic device and the second electronic device is determined based on the RSSI measurement.

16. Tangible, non-transitory, computer-readable media comprising instructions that, when executed, cause processing circuitry to:
determine that a receiver of user equipment has failed to receive a global navigation satellite system (GNSS) location signal for a period of time greater than a threshold period of time,
determine an estimated distance between the user equipment and additional user equipment,
receive, via the receiver, an indication of a unique identifier from the additional user equipment, and
transmit, via a transmitter of the user equipment, an indication of the estimated distance and the unique identifier to a ground station to cause the ground station to perform an action to mitigate interference between the user equipment and the additional user equipment.

17. The tangible, non-transitory, computer-readable media of claim 16, wherein the instructions, when executed, cause the processing circuitry to determine the estimated distance by:
transmitting, via the transmitter, an advertisement beacon to the additional user equipment; and
receiving, via the receiver, a beacon acknowledgement from the additional user equipment.

18. The tangible, non-transitory, computer-readable media of claim 17, wherein the beacon acknowledgement comprises a received signal strength indication (RSSI) measurement indicating a strength of the advertisement beacon.

19. The tangible, non-transitory, computer-readable media of claim 16, wherein the instructions, when executed, cause the processing circuitry to cause the ground station to refrain from scheduling the additional user equipment for uplink to mitigate interference between the user equipment and the additional user equipment based on the estimated distance falling below a distance threshold.

20. The tangible, non-transitory, computer-readable media of claim 16, wherein the instructions, when executed, cause the processing circuitry to cause the ground station to schedule the user equipment on a first frequency and schedule the additional user equipment on a second frequency different than the first frequency based on the estimated distance falling below a distance threshold.
